(19) United States
(12) Patent Application Publication
(10) Pub. No.: US 2026/0167510 A1
(43) Pub. Date: Jun. 18, 2026

(54) METHODS OF IN SITU CORROSION MITIGATION IN MOLTEN SALT PROCESSES, AND RELATED SYSTEMS

(71) Applicants: Battelle Energy Alliance, LLC, Idaho Falls, ID (US); University of Idaho, Moscow, ID (US)

(72) Inventors: Guoping Cao, Idaho Falls, ID (US); Haiyan Zhao, Idaho Falls, ID (US); Drew Glenna, Idaho Falls, ID (US)

(21) Appl. No.: 19/127,391

(22) PCT Filed: Nov. 8, 2023
(86) PCT No.: PCT/US2023/079152

§ 371 Date: May 5, 2025

Related U.S. Application Data
(60) Provisional application No. 63/383,109, filed on Nov. 10, 2022.

(51) Int. Cl. C01D 3/20; C01F 5/30

(52) U.S. Cl. CPC C01D 3/20; C01F 5/30; C01P 2006/80

(57) ABSTRACT

A method of in situ corrosion mitigation in a molten salt process includes preheating a sparging gas mixture comprising a sparging gas and a carrier gas. The method also includes contacting molten salt with the preheated sparging gas mixture. The method further includes transferring impurities in the molten salt to a surface of the molten salt with the preheated sparging gas mixture. Additional methods are also disclosed.

### CROSS-REFERENCE TO RELATED APPLICATIONS

This application is a national phase entry under 35 U.S.C. § 371 of International Patent Application PCT/US2023/079152, filed Nov. 8, 2023, designating the United States of America and published as International Patent Publication WO 2024/102855 A1 on May 16, 2024, which claims the benefit under Article 8 of the Patent Cooperation Treaty of U.S. Patent Application Ser. No. 63/383,109, filed Nov. 10, 2022.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to methods and systems for removing corrosive impurities from molten salt in molten salt process equipment. More specifically, the disclosure relates to methods of in situ corrosion mitigation in molten salt processes, and related systems.

### BACKGROUND

Many industrial processes employ a molten salt or a mixture of molten salts as a heat transfer and/or thermal storage fluid such as in molten salt reactors or heat transfer subsystems in concentrated solar power plants. Molten salts are used in a number of industrial processes due to their high heat capacity, low cost, and thermal stability.

Vessels and related components (e.g., heat exchangers, pumps, piping, valving) used in the molten salt process often experience corrosion due to the high temperatures and corrosivity of the molten salt employed. Water and oxygen in the molten salt may increase corrosivity of the molten salt. Other impurities (e.g., oxides, chlorides, nitrates, sulfates, sulfides) in molten salts can further add to their corrosive nature.

Corrosion affects the vessels, as well as the valving, piping, and other internal and external ancillary process equipment. As a result, the corrosion increases maintenance and service costs while reducing reliability, safety, and service life of the equipment.

Specialized alloys and coatings have been employed in attempts to reduce the negative effects of corrosion from molten salts. However, such alloys and/or coatings are still subject to varying degrees of corrosion and may add significant cost to molten salt processes. Moreover, the use of such specialized alloys and/or coatings may result in a compromise in important material attributes (e.g., material strength).

The specialized alloys (e.g., nickel alloys) and/or specialized coatings (e.g., nickel, carbon, graphite) have been employed in the construction of equipment utilized in the initial preparation of various molten salt mixtures (e.g., LiF—BeF₂, LiF—NaF—KF, KCl—MgCl₂, NaNO₃—NaNO₂—KNO₃). These processes often occur in a highly corrosive and reactive environment. For example, sparging with CCl₄ or an HF/H₂ gas mixture (e.g., about 20% to about 50% HF) has been implemented to react with at least some of the impurities (e.g., water, oxygen, oxides, chlorides, nitrates, sulfates, sulfides) present in a molten salt or a molten salt mixture when it is initially prepared. As a strong oxidizing agent, HF in the sparging gas reacts with many of the impurities present in an initial molten salt or molten salt mixture, and the reaction products are subsequently removed. Conversely, H₂ in the sparging gas serves to suppress the corrosive nature of the HF with respect to a sparging vessel and/or ancillary equipment utilized in the initial preparation of a molten salt or a molten salt mixture.

However, such specialized alloys and/or specialized coatings are still subject to varying degrees of corrosion, particularly when HF is incorporated into a sparging gas. These specialized alloys and/or specialized coatings also add significantly to the cost of construction of molten salt process vessels and ancillary equipment. Furthermore, the physical properties of specialized alloys (e.g., nickel alloys) and coatings (e.g., nickel, carbon, graphite), such as material strength, may be below acceptable levels for safe use in molten salt process vessels (e.g., molten salt reactors, heat transfer subsystems in concentrated solar power plants) and/or ancillary equipment (e.g., heat exchangers, pumps, piping, valving).

### BRIEF SUMMARY

A method of in situ corrosion mitigation in a molten salt process includes preheating a sparging gas mixture comprises a sparging gas and a carrier gas, and contacting molten salt with the preheated sparging gas mixture. The method also includes transferring impurities in the molten salt to a surface of the molten salt with the preheated sparging gas mixture.

A method of in situ corrosion mitigation in a molten salt process includes contacting molten salt in a molten salt process vessel with a sparging gas mixture comprising one or more sparging gasses and one or more carrier gasses. The method further includes transferring impurities in the molten salt to a surface of the molten salt with the sparging gas mixture.

A method of in situ corrosion mitigation in molten salt process equipment comprises: preheating a sparging gas mixture; contacting molten salt in a molten salt process vessel with the preheated sparging gas mixture comprising hydrogen and argon; transferring impurities in the molten salt to a surface of the molten salt with the preheated sparging gas mixture; removing the impurities transferred from the surface of the molten salt; recovering sparging off-gasses discharged from the molten salt process vessel, the sparging off-gasses comprising the preheated sparging gas mixture and one or more of gaseous impurities, liquid impurities, and solid impurities entrained therein; separating at least the hydrogen from the recovered sparging off-gasses; and recycling the hydrogen.

### BRIEF DESCRIPTION OF THE DRAWINGS

FIG. 1 is a simplified diagrammatic view of a system for in situ corrosion mitigation in a molten salt process, in accordance with embodiments of the disclosure.

FIG. 2 is a block diagram of a method of in situ corrosion mitigation in a molten salt process, in accordance with embodiments of the disclosure.

FIG. 3 is a simplified schematic view of a gas sparging system for a molten salt vessel, in accordance with embodiments of the disclosure.

FIG. 4 is a perspective view of the molten salt vessel of FIG. 3, in accordance with embodiments of the disclosure.

FIG. 5 is a simplified schematic view of an alternative gas sparging system for a molten salt vessel, in accordance with embodiments of the disclosure.

### DETAILED DESCRIPTION

The following description provides specific details, such as material compositions, shapes, and sizes, to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only and are not meant to be actual views of any particular material, component, structure, sensor device, or system. Variations from the shapes depicted in the drawings as a result, for example, of manufacturing techniques and/or tolerances, are to be expected. Thus, embodiments described herein are not to be construed as being limited to the particular shapes. The drawings are not necessarily to scale. Elements that are common between figures may retain the same numerical designation.

As used herein, the singular forms “a,” “an,” and “the” are intended to include the plural forms as well, unless the context clearly indicates otherwise.

As used herein, “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, percentage (%) concentrations of a gas in a sparging gas mixture are expressed as volumetric percentages.

As used herein, the term “molten salt” means and includes a single molten salt or a mixture of two or more molten salts, wherein the molten salt may be in a substantially purified form or may include one or more additives and/or impurities.

A molten salt is a salt that is in a solid phase at standard temperature and pressure conditions (e.g., from about 20 degrees Celsius (C) to about 25° C. and about 101 kilopascals (kPa)) but is in a liquid phase at elevated temperatures and/or reduced pressures. A molten salt may include one or more halide-based salts, such as a chloride salt, a bromide salt, an iodide salt, or a fluoride salt, a nitrate salt, a carbonate salt, a hydroxide salt, or a combination thereof. By way of example only, a molten salt may include, but is not limited to, sodium chloride (NaCl), magnesium chloride (MgCl₂), potassium chloride (KCl), strontium chloride (SrCl₂), calcium chloride (CaCl₂)), rubidium chloride (RbCl), thulium trichloride (TmCl₃), lithium chloride (LiCl), uranium trichloride (UCl₃), uranium tetrachloride (UCl₄), sodium bromide (NaBr), lithium bromide (LiBr), potassium bromide (KBr), cesium bromide (CsBr), calcium bromide (CaBr₂), strontium bromide (SrBr₂), sodium iodide (NaI), sodium fluoride (NaF), lithium fluoride (LiF), beryllium fluoride (BeF₂), uranium tetrafluoride (UF₄), thorium tetrafluoride (ThF₄), zirconium tetrafluoride (ZrF₄), cerium trifluoride (CeF₃), plutonium trifluoride (PuF₃), sodium nitrate (NaNO₃), potassium nitrate (KNO₃), sodium carbonate (Na₂CO₃), potassium carbonate (K₂CO₃), lithium carbonate (Li₂CO₃), sodium hydroxide (NaOH), potassium hydroxide (KOH), lithium hydroxide (LiOH), and combinations thereof.

Molten salt process vessels and ancillary molten salt process equipment (collectively referred to herein as molten salt process equipment), such as reactors, heat exchangers, pumps, piping, valving, and other process components, which contain and/or come into contact with the molten salt are exposed to corrosive conditions due to the extreme temperatures and compositions of the molten salt. The molten salt process equipment may be used in a molten salt process or to form the molten salt. Introducing a sparging gas into a molten salt in molten salt process equipment may remove one or more impurities (e.g., remove some impurities, remove substantially all impurities) from the molten salt that may accumulate as a result of the operation of a molten salt process. As before, impurities (e.g., water, oxygen, oxides, chlorides, nitrates, sulfates, sulfides) in the molten salt may act to increase the corrosivity of the molten salt in a particular molten salt process environment, i.e., increase the corrosivity of the molten salt to a particular material of construction of the molten salt process vessels and/or ancillary molten salt process equipment. A sparging gas may also remove one or more impurities from a molten salt, wherein the impurities may include compounds that function as redox agents with respect to the material(s) of construction of the molten salt process equipment.

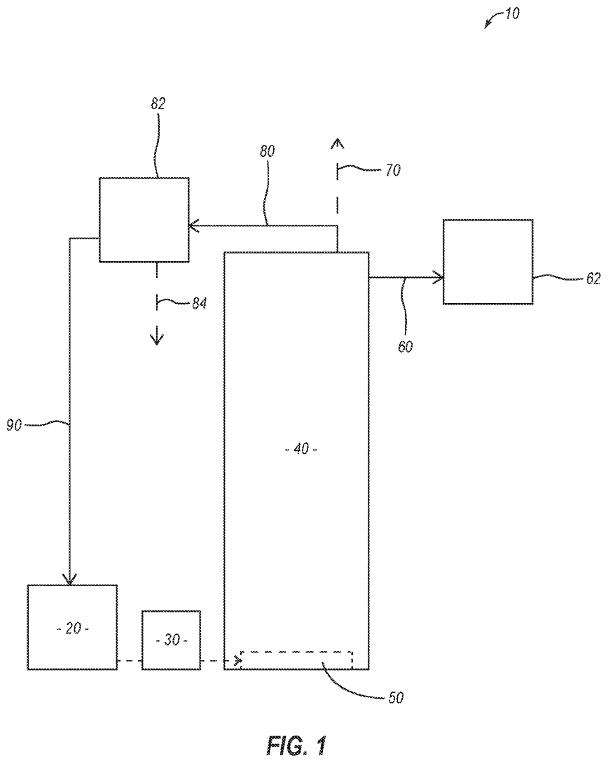

With reference to FIG. 1, presented therein is a simplified diagrammatic view of a system 10 for in situ corrosion mitigation in a molten salt process, in accordance with embodiments of the disclosure. The system 10 includes a sparging gas supply 20 dimensioned and configured to contain an amount of a sparging gas mixture sufficient to contact a volume of molten salt in a molten salt process vessel 40 of the system 10. The sparging gas supply 20 may be pressurized to a pressure greater than an operating pressure of the molten salt process vessel 40, such that the sparging gas mixture may be released into the molten salt process vessel 40 under pressure without the use of other motive equipment. In some embodiments, a sparging gas supply 20 includes a pump (e.g., diaphragm pump, vacuum pump) to transfer the sparging gas mixture from the sparging gas supply 20 to the molten salt process vessel 40.

A sparging gas mixture includes a carrier gas and a sparging gas. A carrier gas may be a substantially inert gas, for example, a noble gas. In some embodiments, the carrier gas may comprise argon, nitrogen, helium, or combinations thereof. The sparging gas mixture may include other noble gases or other substantially inert (e.g., nonreactive, substantially nonreactive) gases as the carrier gas. Although substantially inert, a carrier gas may affect the solubility of water, oxygen, or other impurities (e.g., oxides, chlorides, nitrates, sulfates, sulfides) in the molten salt. In at least some embodiments, a sparging gas mixture may also include small amounts of other gases having desired reactive interactions with one or more of the impurities in a particular molten salt. The sparging gas mixture may further include trace amounts (e.g., impurity amounts) of other gases or vapors, which may have little or no effect on the molten salt or the molten salt process equipment.

In accordance with some embodiments of the disclosure, a carrier gas in a sparging gas mixture comprises argon. In other embodiments, the carrier gas comprises helium, and in yet other embodiments, a carrier gas in the sparging gas mixture comprises nitrogen. A sparging gas mixture may include a carrier gas comprising a combination of argon, helium, and/or nitrogen.

A sparging gas may also be substantially inert (e.g., nonreactive, substantially nonreactive) with respect to the molten salt and the materials of construction of a molten salt process vessel 40 and associated ancillary molten salt process equipment (e.g., heat exchangers, pumps, piping, valving). A sparging gas mixture may have a sparging gas concentration ranging from about 0.1% to about 50% in the carrier gas, such as, for example, from about 0.1% to about 1%, from about 1% to about 10%, from about 10% to about 20%, from about 20% to about 30%, from about 30% to about 40%, or from about 40% to about 50%.

A sparging gas in accordance with embodiments of the disclosure may comprise hydrogen. In some embodiments, a sparging gas mixture includes a hydrogen concentration of from about 0.1% to about 50% by volume, such as from about 0.5% to about 40%, from about 1.0% to about 30%, from about 2.0% to about 20%, or from about 4.0% to about 10%. In at least some embodiments, the sparging gas mixture comprises approximately 4% or less of hydrogen by volume such that the sparging gas mixture remains below a lower explosive limit (LEL) of hydrogen in air to facilitate safe handling and to minimize (e.g., reduce, eliminate) the need for specialized equipment for the storage and/or handling of the sparging gas mixture in the system 10.

Without limiting the scope of the disclosure, a sparging gas mixture may remove impurities, which include corrosive compounds, in the form of dissolved gases (e.g., oxygen gas, water vapor), liquids (e.g., liquid water) and/or solids and particulate matter, thereby reducing, i.e., mitigating, the corrosivity of the molten salt. In some embodiments, the sparging gas mixture may physically displace dissolved gaseous impurities, as well as liquid and solid impurities, and transfer the dissolved gaseous impurities, and the liquid and solid impurities to the surface of the molten salt. Specifically, as the sparging gas mixture contacts the molten salt and flows upwardly through the molten salt in a molten salt process vessel 40, the sparging gas mixture may physically displace and transfer the dissolved gaseous, liquid and solid impurities to the surface of the molten salt. In some embodiments, the sparging gas mixture is introduced into the molten salt in a molten salt process vessel 40 while the molten salt process vessel 40 remains online and in operation. As a result of the carrier gas and the sparging gas of a sparging gas mixture being substantially inert (e.g., nonreactive, substantially nonreactive) with the materials of construction of the molten salt process vessel 40 and the ancillary molten salt process equipment, sparging may be conducted without adversely affecting the molten salt process. Thus, the system 10 may be employed to implement in situ corrosion mitigation (e.g., quarterly, monthly, weekly, daily, continuously) in a molten salt process vessel 40 and ancillary molten salt process equipment.

The sparging gas mixture may affect the pH of the water and/or other impurities in the molten salt, which may subsequently affect the solubility of the water or other impurities (e.g., oxides, chlorides, nitrates, sulfates, sulfides) in the molten salt. The sparging gas (e.g., hydrogen) in the sparging gas mixture may, in at least some embodiments, act as a reducing agent (e.g., mild reducing agent) targeting specific impurities in a molten salt, while being essentially nonreactive (e.g., substantially nonreactive, completely nonreactive) with the materials of construction of a molten salt process vessel 40 and ancillary molten salt process equipment (e.g., heat exchangers, pumps, valves, piping). By way of example, hydrogen in a sparging gas mixture may react with some of the impurities (e.g., Fe²⁺, Fe³⁺, Ni²⁺) in a molten salt, forming a solid reaction product that may be physically transferred with the sparging gas mixture to the surface of the molten salt in the molten salt process vessel 40, for subsequent removal. In some embodiments, a sparging gas mixture may be used to physically transfer dissolved gaseous, liquid and/or solid impurities in the molten salt in a molten salt process vessel 40 to the surface of the molten salt in the molten salt process vessel, where they may be removed by an appropriate mechanism (e.g., off-gassing, skimming, filtration).

In embodiments in which the molten salt includes dissolved water and/or oxygen, the sparging gas mixture may remove (e.g., substantially remove, completely remove) the dissolved water and/or oxygen from the molten salt, by physically transferring the dissolved water and/or oxygen to the surface of the molten salt in a molten salt process vessel 40 where it may be removed for subsequent processing and/or disposal. As the sparging gas mixture is introduced into the molten salt, the hydrogen in the sparging gas mixture may react with oxygen in the molten salt to form water, wherein the water may be gaseous (e.g., water vapor) at the operating conditions (e.g., temperature from 225° C. to about 1,400° C., pressure from about 101 kPa and about 506 kPa). At least some of the water present in the molten salt may react with chloride salts or other halide salts in the molten salt to form hydrogen chloride (HCl) or other mineral acids, which may also subsequently be removed from the molten salt by the sparging gas mixture. Unreacted water may be removed from the molten salt by the sparging gas mixture, as before.

Therefore, in accordance with embodiments of a system 10 for in situ corrosion mitigation in molten salt processes, contacting a gas sparging mixture with a molten salt in a molten salt process vessel 40 may reduce (e.g., mitigate, substantially mitigate) the redox potential of the molten salt, which may also reduce (e.g., mitigate, substantially mitigate) corrosion of the materials of construction of the molten salt process vessel 40 and/or ancillary molten salt process equipment (e.g., heat exchangers, pumps, piping, valving) that come into contact with the molten salt.

In some embodiments, a sparging gas mixture may be used to remove solid fission products, which may include solid particles, from molten chloride salt reactors. As one example, the following reaction may be promoted by introducing a sparging gas, i.e., hydrogen gas, into a molten salt that contains uranium tetrachloride (UCl₄) in a molten chloride salt reactor:

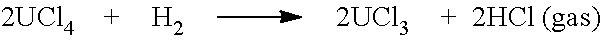

The hydrogen chloride gas formed in the above reaction may be removed (e.g., physically displaced) from the molten salt by the sparging gas mixture and may be subsequently removed from the molten chloride salt reactor.

In accordance with at least some embodiments of the disclosure, a sparging gas mixture may be purified prior to introduction to a molten salt. Constituent gasses, i.e., a carrier gas and a sparging gas may be individually purified prior to combining to create a purified sparging gas mixture. Alternatively, a gas sparging mixture may be purified after combining the carrier gas and the sparging gas to form the sparging gas mixture. Purification may include removing (e.g., substantially removing) water, oxygen, and other impurities (e.g., oxides, chlorides, nitrates, sulfates, sulfides) from the sparging gas mixture prior to commencing gas sparging. In at least some embodiments, a carrier gas, a sparging gas and/or a sparging gas mixture may have a purity of at least about 90%, or at least about 99%, or at least about 99.9%, or at least about 99.99%.

With reference again to FIG. 1, in at least some embodiments, a system 10 for in situ corrosion mitigation in a molten salt process includes an optional preheat assembly 30. Operating conditions (e.g., temperature conditions, pressure conditions) within a molten salt process vessel 40 may be sufficient to maintain the molten salt in a liquid phase. By way of example, the temperature of molten salt within a molten salt process vessel 40 may be from about 225° C. to about 1,400° C. As a further example, the pressure within a molten salt process vessel 40 may be from about 101 kPa to about 506 kPa. A preheat assembly 30 may be disposed downstream of a sparging gas supply 20, as shown in FIG. 1, to preheat a sparging gas mixture prior to contacting the sparging gas mixture with molten salt in the molten salt process vessel 40. Specifically, a preheat assembly 30 may be employed to increase the temperature of a sparging gas mixture to approximate a temperature of the molten salt within a molten salt process vessel (e.g., from about 225° C. to about 1,400° C.). Preheating the sparging gas mixture may further minimize (e.g., eliminate) disruption to the molten salt process in the molten salt process vessel 40 by minimizing (e.g., eliminating) the formation of temperature gradients in the molten salt as a result of introducing the sparging gas mixture into the molten salt in the molten salt process vessel 40. While the preheat assembly 30 is shown in the simplified diagrammatic view of FIG. 1 as a separate unit, in at least some embodiments, a sparging gas supply 20 may include a preheat assembly 30 integrally incorporated therewith.

Looking again to FIG. 1, a system 10 for in situ corrosion mitigation in a molten salt process also includes a diffuser assembly 50 disposed in the molten salt process vessel 40. The diffuser assembly 50 may be installed during initial construction of a molten salt process vessel 40. Alternatively, a molten salt process vessel 40 may be retrofitted to incorporate a diffuser assembly 50. In some embodiments, a diffuser assembly 50 includes one or more diffusers mounted in a lower portion (e.g., bottom) of the molten salt process vessel 40. The one or more diffusers may comprise sparging discs formed of a porous material. Alternatively, the diffuser assembly 50 may comprise other devices for diffusing and/or bubbling a sparging gas mixture into a liquid (e.g., molten salt). The diffusers may be manufactured from various metals and/or metal alloys, including sintered stainless steel, and in some embodiments, a diffuser comprises a sintered disc. The one or more diffusers of a diffuser assembly 50 may have different diffuser pore sizes that at least in part regulate the size (e.g., diameter) of the sparging gas mixture bubbles discharged therefrom and into the molten salt. The diffuser pore size may be selected based on one or more process conditions (e.g., sparging gas mixture flowrate, sparging gas mixture composition, molten salt composition). In some embodiments, a diffuser may have a pore size of from about 1 micron to about 50 microns, such as, from about 5 microns to about 25 microns. The pore size may, for example, be about 5 microns, or about 15 microns.

The sparging gas mixture may be transferred to the diffuser assembly 50 via one or more sparging tubes. As one example, a single sparging tube may direct the sparging gas mixture into a single diffuser of the diffuser assembly 50. Alternatively, multiple sparging tubes may direct portions of the sparging gas mixture to one or more respective diffusers of the diffuser assembly 50, to introduce the sparging gas mixture more evenly into contact with molten salt in a molten salt process vessel 40.

The sparging gas mixture may be introduced (e.g., injected) into the molten salt in a molten salt process vessel 40, while the molten salt process vessel 40 remains online and in operation, via a diffuser assembly 50 at one or more predetermined flowrates. The sparging gas mixture flowrate may be determined, at least in part, from the amount of impurities (e.g., water, oxygen, oxides, chlorides, nitrates, sulfates, sulfides) in the molten salt and/or a desired rate of removal of the impurities from the molten salt. In some embodiments, the sparging gas mixture flowrate may be from about 1 liter (L) sparging gas/100 L molten salt per minute to about 10 L sparging gas/100 L molten salt per minute. Under some conditions, it may be desirable to conduct high-rate gas sparging having a higher concentration of hydrogen in the sparging gas mixture (e.g., from about 4% H₂ to about 10% H₂) and/or introducing the sparging gas mixture into the molten salt at a higher flowrate (e.g., from about 10 L sparging gas/100 L molten salt per minute to about 30 L sparging gas/100 L molten salt per minute). High-rate gas sparging may be used when the molten salt includes a relatively high amounts of impurities.

The carrier gas and the sparging gas may be combined and stored as a sparging gas mixture in a sparging gas supply 20 prior to contacting molten salt in a molten salt process vessel 40 via a diffuser assembly 50. Alternatively, the carrier gas and the sparging gas may be supplied individually and mixed inline, such as via an inline gas mixer, prior to (e.g., upstream of) the diffuser assembly 50. In at least some embodiments, the carrier gas and the sparging gas may be supplied independently and directly into molten salt in a molten salt process vessel 40 via one or more diffusers of a diffuser assembly 50.

A system 10 for in situ corrosion mitigation in a molten salt process may also include an impurity discharge 60, as shown in FIG. 1. An impurity discharge 60 is disposed in communication with an upper portion of the molten salt process vessel 40 and is dimensioned and configured to receive the solid and/or liquid impurities physically transferred from the molten salt in the molten salt process vessel 40 to the surface of the molten salt for collection and removal therefrom. The impurities (e.g., liquid impurities, solid impurities) transferred to the surface of the molten salt may be removed by any of a number of appropriate mechanisms (e.g., overflows, skimmers, bubblers). An impurity processing unit 62 may be configured to process (e.g., by filtration, dewatering, centrifugation, neutralization) the solid impurities and/or liquid impurities removed from the molten salt in the molten salt process vessel 40 to facilitate safe handling and subsequent disposal thereof.

With continued reference again to FIG. 1, a system 10 for in situ corrosion mitigation in a molten salt process may include an optional sparging off-gas discharge 70 disposed in communication with the molten salt process vessel 40. In some embodiments, a sparging off-gas discharge 70 is disposed in communication with an upper portion (e.g., a vapor head space) of a molten salt process vessel 40. The sparging off-gasses, i.e., the sparging gas mixture combined with gaseous impurities from the molten salt in the molten salt process vessel 40 are transferred to the surface of the molten salt, may be removed from the molten salt process vessel 40 (e.g., removed from the vapor head space). The sparging off-gasses may also contain liquid impurities and/or solid particulate impurities removed (e.g., physically displaced) from the molten salt and entrained therein. In some embodiments, the sparging off-gasses may include water vapor, hydrogen chloride, and/or other products of reactions between hydrogen in the sparging gas mixture and impurities in the molten salt. The sparging off-gas discharge 70, in at least some embodiments, may be vented directly to atmosphere into which the sparging off-gasses are discharged without processing (e.g., without treatment).

In some embodiments, a system 10 for in situ corrosion mitigation in a molten salt process may include an optional sparging off-gas recovery line 80 that directs sparging off-gasses discharged from the molten salt process vessel 40 to a sparging off-gas processing unit 82. A sparging off-gas processing unit 82 may be dimensioned and configured to recover (e.g., separate) sparging process gasses (e.g., sparging gas, carrier gas, sparging gas mixture) in the sparging off-gasses from the gaseous impurities and/or liquid and solid particulate impurities entrained therein. In at least some embodiments, a sparging off-gas processing unit 82 includes a sparging gas recovery line 90, wherein the sparging process gasses (e.g., sparging gas, carrier gas, sparging gas mixture) recovered (e.g., separated) from the sparging off-gasses are returned to the sparging gas supply 20 for reuse in the system 10. In some embodiments, the recovered sparging gasses are purified prior to reintroduction to a sparging gas supply 20. Specifically, the recovered sparging process gasses (e.g., sparging gas, carrier gas, sparging gas mixture) may be purified to a purity of at least about 90%, such as a purity of at least about 99%, a purity of at least about 99.9%, or a purity of at least about 99.99%, prior to reintroduction into a sparging gas supply 20.

In some embodiments, a sparging off-gas processing unit 82 also includes an optional secondary sparging gas off-gas discharge line 84, wherein the gaseous impurities and/or liquid and solid particulate impurities removed from the molten salt in the sparging off-gasses and separated from the recovered sparging process gasses (e.g., sparging gas, carrier gas, sparging gas mixture) are discharged for further treatment and/or disposal.

A system 10 for in situ corrosion mitigation in a molten salt process may include associated ancillary equipment (e.g., pumps, valves, flow regulators/controllers, pressure relief valves, check valves, etc.) to direct flow of a sparging gas mixture from a sparging gas supply 20 to a molten salt process vessel 40 that contains molten salt. The associated ancillary equipment (e.g., pumps, valves, flow regulators/controllers, pressure relief valves, check valves, etc.) may be used to direct the sparging off-gasses, including gaseous, liquid and/or solid impurities removed from the molten salt, from the molten salt process vessel 40 to an impurity discharge 60 and/or an impurity processing unit 62, a sparging off-gas discharge 70, a sparging off-gas recovery line 80, a sparging off-gas processing unit 82, a secondary off-gas discharge line 84 and/or a sparging gas recovery line 90. Such associated ancillary equipment may be manufactured from materials suitable for the molten salt and the sparging gas mixture contacted therewith. For example, associated ancillary equipment that comes into direct contact with molten salt (e.g., pumps, valves, flow regulators/controllers, pressure relief valves, check valves, etc.) may be manufactured of stainless steel (e.g., 316H stainless steel). Additionally, certain associated ancillary equipment (e.g., components that direct outflow of sparging off-gasses) may be manufactured from materials that are resistant to (e.g., nonreactive with, substantially nonreactive with) the impurities (e.g., water, oxygen, oxides, chlorides, nitrates, sulfates, sulfides) removed from the molten salt.

A system 10 for in situ corrosion mitigation in a molten salt process may be implemented as a continuous process in molten salt in a molten salt process vessel 40, wherein molten salt is continuously sparged in the molten salt process vessel 40 with a sparging gas mixture while the molten salt process vessel 40 remains in operation in a molten salt process. Alternatively, a system 10 for in situ corrosion mitigation in a molten salt process may be implemented in molten salt in a molten salt process vessel 40 in a batch process, wherein a molten salt process vessel 40 is temporarily taken offline from the molten salt process while a batch sparging process is implemented.

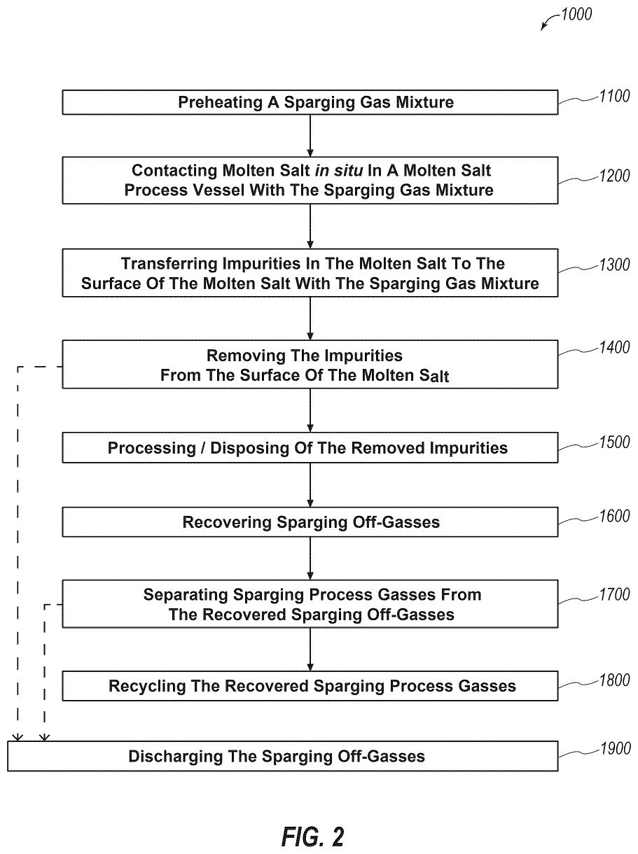

Embodiments of the disclosure further encompass a method of in situ corrosion mitigation in a molten salt process. FIG. 2 is a block diagram of a method 1000 of in situ corrosion mitigation in a molten salt process, in accordance with embodiments of the disclosure. As shown in FIG. 2, the method 1000 of in situ corrosion mitigation in a molten salt process includes the act 1100 of preheating a sparging gas mixture. As before, a sparging gas mixture includes at least one substantially inert carrier gas and at least one substantially nonreactive sparging gas. In at least some embodiments, a sparging gas mixture includes an amount of hydrogen (e.g., about 4% or less) in argon. The act 1100 of preheating a sparging gas mixture, in at least some embodiments, comprises preheating a sparging gas mixture to approximate a temperature of molten salt in a molten salt process vessel (e.g., from about 225° C. to about 1,400° C.).

With continued reference to FIG. 2, a method 1000 of in situ corrosion mitigation in a molten salt process may also include act 1200 of contacting molten salt in a molten salt process vessel with the sparging gas mixture. One or more diffusers of a diffuser assembly may be disposed in a molten salt process vessel in contact with molten salt contained therein. In some embodiments, one or more diffusers may be disposed in a lower portion (e.g., bottom) of a molten salt process vessel to allow introduction of a sparging gas mixture evenly into contact with the volume of molten salt contained therein.

The method 1000 of in situ corrosion mitigation in a molten salt process further comprises the act 1300 of transferring impurities (e.g., gaseous impurities, liquid impurities, solid impurities) in the molten salt in the molten salt process vessel to the surface of the molten salt with the sparging gas mixture. As before, the sparging gas mixture acts to physically displace and transfer impurities (e.g., gaseous impurities, liquid impurities, solid impurities) in the molten salt to the surface of the molten salt with the sparging gas mixture to facilitate removal therefrom.

The method 1000 of in situ corrosion mitigation in a molten salt process also includes the act 1400 of removing the impurities (e.g., liquid impurities, solid impurities) from the surface of the molten salt in the molten salt process vessel. The impurities (e.g., liquid impurities, solid impurities) transferred to the surface of the molten salt may be removed by any of a number of appropriate mechanisms (e.g., overflows, skimmers, bubblers). In some embodiments, the method 1000 of in situ corrosion mitigation in a molten salt process may comprise the act 1500 of processing and/or disposing of the removed impurities, and, in particular, processing and/or disposing of solid impurities and/or liquid impurities removed from the surface of the molten salt in the molten salt process vessel. In some embodiments, the removed impurities may be subjected to one or more of filtration, dewatering, centrifugation, and neutralization processes prior to disposal thereof.

Looking again to FIG. 2, the method 1000 of in situ corrosion mitigation in a molten salt process may comprise the act 1600 of recovering sparging off-gasses. As before, sparging off-gasses may include the sparging gas mixture combined with gaseous impurities removed from molten salt in a molten salt process vessel, as well as liquid and/or solid particulate impurities that may be entrained in the sparging off-gasses. In some embodiments, the method 1000 of in situ corrosion mitigation in a molten salt process may comprise the act 1700 of separating one or more sparging process gasses (e.g., a carrier gas, a sparging gas, a sparging gas mixture) from the recovered sparging off-gasses. Specifically, the method 1000 may include separating sparging process gasses (e.g., a sparging gas, a carrier gas, a sparging gas mixture) from the impurities (e.g., gaseous impurities, liquid impurities, solid impurities) in the recovered sparging off-gasses, such that the sparging process gasses (e.g., sparging gas, carrier gas, sparging gas mixture) may be recycled for reuse. As such, in accordance with at least some embodiments of the disclosure, a method 1000 of in situ corrosion mitigation in a molten salt process includes the act 1800 of recycling the recovered sparging process gasses. In some embodiments, recovered sparging process gasses are purified prior to reintroduction to a sparging gas supply. Specifically, recovered sparging gasses may be purified to a purity of at least about 90%, or a purity of at least about 99%, or a purity of at least about 99.9%, or a purity of at least about 99.99%, prior to reintroduction into a sparging gas supply.

With reference again to FIG. 2, a method 1000 of in situ corrosion mitigation in a molten salt process may include the act 1900 of discharging the sparging off-gasses. As may be seen from FIG. 2, the sparging off-gasses may be discharged without processing, such as via a sparging off-gas discharge 70 (FIG. 1), as indicated by the dashed line from act 1400 to act 1900 in FIG. 2. Alternatively, the method 1000 may include the act 1900 of discharging the sparging off-gasses after subsequent processing via a sparging off-gas processing unit 82 (FIG. 1). In at least some embodiments, one portion of the sparging off-gasses may be directly discharged to atmosphere without processing and another portion of the sparging off-gasses may be discharged after processing (e.g., after processing via a sparging off-gas processing unit 82 (FIG. 1)).

While the systems 10 and methods 1000 according to embodiments of the disclosure, may be used to remove impurities (e.g., water, oxygen, oxides, chlorides, nitrates, sulfates, sulfides) from molten salt in a molten salt process vessel 40 (e.g., a molten chloride salt reactor), in some embodiments, the systems 10 and methods 1000 may also be used to remove impurities in other molten salt applications (e.g., batteries that employ a molten salt).

The following examples serve to explain embodiments of the disclosure in more detail. These examples are not to be construed as being exhaustive or exclusive as to the scope of this invention.

### EXAMPLES

### Example 1

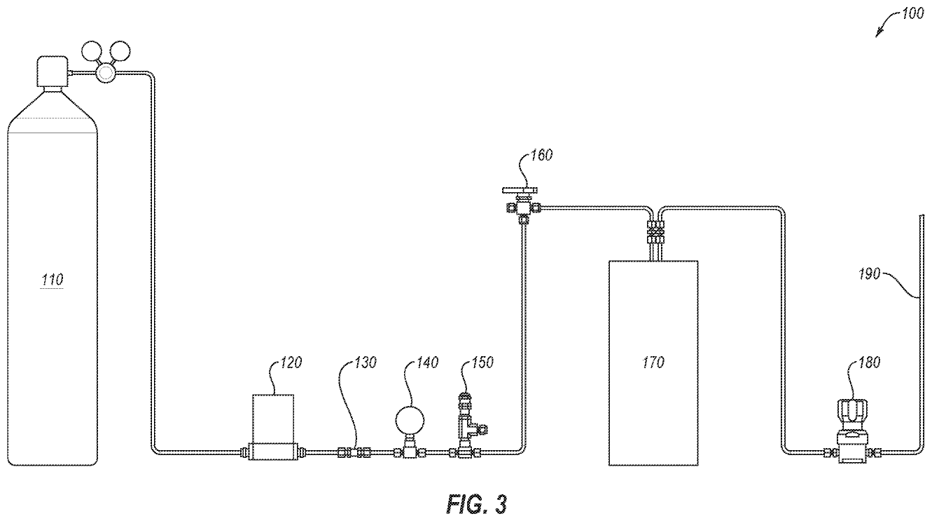

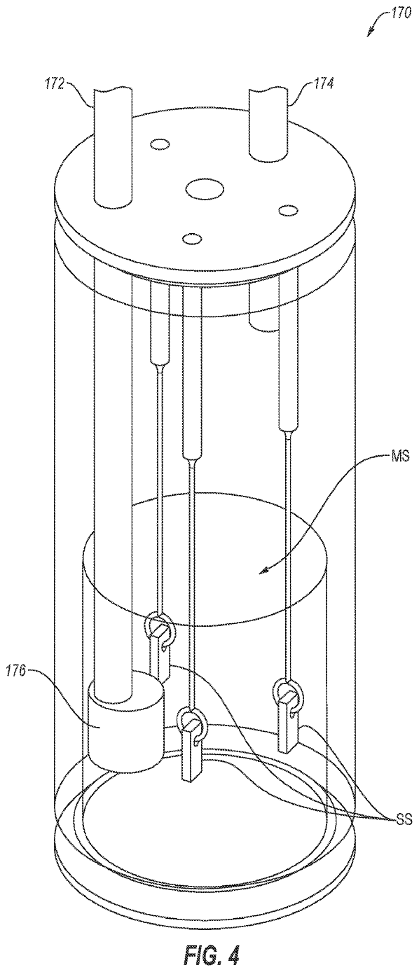

Referring to FIG. 3, a simplified schematic view of a gas sparging system 100 is partially depicted. Sparging gas mixture supply lines manufactured from 316L stainless steel carried a sparging gas mixture from a sparging gas mixture supply 110 to a mass flow controller 120, which regulated the sparging gas mixture flowrate into and through a molten salt mixture MS (FIG. 4) in a first molten salt vessel 170, i.e., a crucible. The sparging gas mixture supply 110 contained a sparging gas mixture comprising approximately 4% hydrogen in argon. The gas sparging system 100 also included a check valve 130, a pressure gauge 140, a pressure relief valve 150, and a three-way valve 160 installed inline between the mass flow controller 120 and the first molten salt vessel 170, as shown in FIG. 3. A back pressure regulator 180 and a sparging off-gas outlet line 190 were connected downstream of the first molten salt vessel 170, also with 316L stainless steel lines. The operation of the gas sparging system 100 was conducted under a fume hood (not shown), and sparging off-gasses discharged from the sparging off-gas outlet line 190 were vented into the fume hood.

A molten salt mixture MS (FIG. 4) was prepared from anhydrous sodium chloride (NaCl) and magnesium chloride (MgCl₂) salts, wherein the molten salt mixture MS included about 44% by weight NaCl and about 56% by weight MgCl₂. The first molten salt vessel 170 was charged with an amount of about 100 milliliters (ml) of the molten salt mixture MS. As shown in FIG. 4, the first molten salt vessel 170 was equipped with a sparging gas inlet line 172 having a sparging disc 176 mounted to a distal end thereof for delivering and diffusing, respectively, the sparging gas mixture into the molten salt mixture MS. A sparging gas outlet line 174 was mounted in communication with the vapor head space of the first molten salt vessel 170 and was connected to the sparging off-gas outlet line 190, such that sparging off-gasses were vented into the fume hood. A second molten salt vessel (not shown) was also charged with an amount of about 100 ml of the anhydrous sodium chloride (NaCl) and magnesium chloride (MgCl₂) molten salt mixture.

Three (3) type 316H stainless steel alloy test samples SS each having an initial weight per surface area of about 340 milligrams per centimeter squared (mg/cm²) were immersed in the molten salt mixture MS in the first molten salt vessel 170. Three (3) type 316H stainless steel alloy control samples (not shown) each also having an initial weight per surface area of about 340 mg/cm² were immersed in the molten salt mixture MS in the second containment salt vessel (not shown). The molten salt mixtures MS in each of the first molten salt vessel 170 and the second molten salt vessel were maintained at a temperature of about 700° C. throughout the approximately 500-hour test period.

The sparging gas mixture was continuously injected into the molten salt mixture MS in the first molten salt vessel 170 having the three (3) stainless steel alloy test samples SS suspended therein at a flowrate of about 5 milliliters per minute for the duration of the 500-hour test period. The molten salt mixture MS in the second molten salt vessel having the three (3) stainless steel alloy control samples suspended therein, received no gas sparging during the 500-hour test period.

Following continuous immersion of the three (3) stainless steel alloy test samples SS and the three (3) stainless steel alloy control samples in their respective molten salt mixtures MS for the duration of the approximately 500-hour test period, each of the stainless steel alloy test samples SS and the stainless steel alloy control samples were weighed and compared to their respective initial weights per surface area. Each of the three (3) stainless steel alloy control samples, which were suspended in the molten salt mixture without gas sparging, lost an average of 1.03 mg/cm² per day. Notably, each of the stainless steel alloy test samples SS that were suspended in the molten salt mixture MS that received continuous gas sparging with the gas sparging mixture for the duration of the 500-hour test period only lost an average of about 0.64 mg/cm² per day, i.e., only about 62% of the loss observed for the stainless steel alloy control samples that received no gas sparging. Accordingly, it may be concluded that gas sparging with the gas sparging mixture comprising approximately 4% hydrogen in argon as disclosed herein had a mitigating effect on the corrosivity of the molten salt mixture on the sample materials, i.e., type 316H stainless steel alloy.

### Example 2

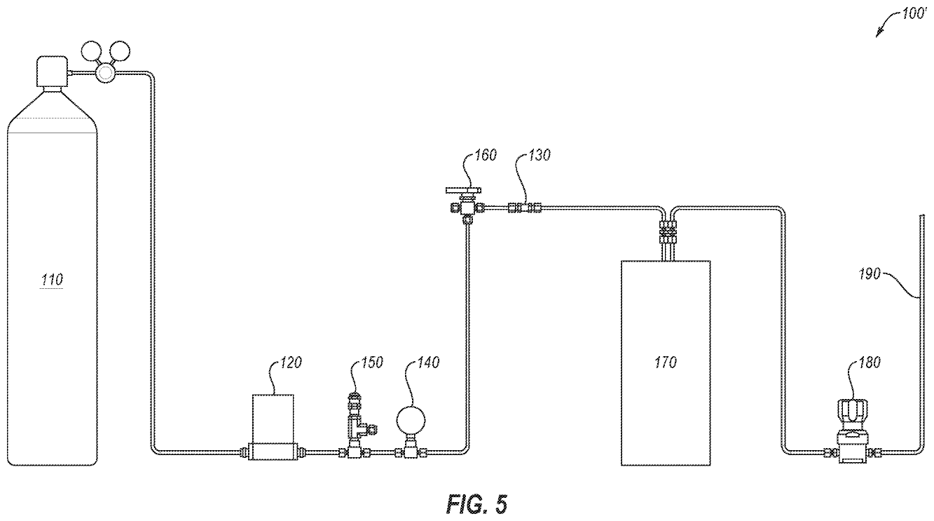

FIG. 5 is a simplified schematic view of an alternative gas sparging system 100′ for a molten salt vessel, in accordance with embodiments of the disclosure. The gas sparging system 100′ depicted in FIG. 5 is essentially the same as the system of FIG. 3 except for some of the components being disposed in alternate arrangements relative to one another. Specifically, as may be seen from FIG. 5, the pressure relief valve 150 is directly downstream of the mass flow controller 120, followed by the pressure gauge 140, the three-way valve 160, and, finally, the check valve 130.

Additional nonlimiting example embodiments of the disclosure are set forth below.
Embodiment 1: A method of in situ corrosion mitigation in a molten salt process, the method comprising: preheating a sparging gas mixture comprising a sparging gas and a carrier gas; contacting molten salt with the preheated sparging gas mixture; and transferring impurities in the molten salt to a surface of the molten salt with the preheated sparging gas mixture.
Embodiment 2: The method of Embodiment 1, further comprising removing the impurities transferred to the surface of the molten salt.
Embodiment 3: The method of Embodiment 2, further comprising processing the impurities removed from the surface of the molten salt.
Embodiment 4: The method of Embodiment 1, further comprising discharging sparging off-gasses comprising the preheated sparging gas mixture and one or more of gaseous impurities, liquid impurities and solid impurities entrained within.
Embodiment 5: The method of Embodiment 1, further comprising recovering sparging off-gasses comprising the preheated sparging gas mixture and one or more of gaseous impurities, liquid impurities and solid impurities entrained within.
Embodiment 6: The method of Embodiment 5, further comprising separating the sparging gas of the sparging gas mixture from the sparging off-gasses.
Embodiment 7: The method of Embodiment 6, further comprising recycling the sparging gas separated from the sparging off-gasses.
Embodiment 8: The method of Embodiment 5, further comprising separating the carrier gas of the sparging gas mixture from the sparging off-gasses.
Embodiment 9: A method of in situ corrosion mitigation in a molten salt process, the method comprising: contacting molten salt in a molten salt process vessel with a sparging gas mixture, the sparging gas mixture comprising one or more sparging gasses and one or more carrier gasses; and transferring impurities in the molten salt to a surface of the molten salt with the sparging gas mixture.
Embodiment 10: The method of Embodiment 9, wherein contacting molten salt in a molten salt process vessel with a sparging gas mixture comprises contacting molten salt in the molten salt process vessel with the sparging gas mixture exhibiting a purity of at least about 99.9 percent.
Embodiment 11: The method of Embodiment 9, wherein contacting molten salt in a molten salt process vessel with a sparging gas mixture comprises contacting molten salt in the molten salt process vessel with the sparging gas mixture comprising hydrogen and the carrier gas.
Embodiment 12: The method of Embodiment 9, wherein contacting molten salt in a molten salt process vessel with a sparging gas mixture comprises contacting molten salt in the molten salt process vessel with the sparging gas mixture comprising the sparging gas and argon.
Embodiment 13: The method of Embodiment 9, wherein contacting molten salt in a molten salt process vessel with a sparging gas mixture comprises contacting molten salt in the molten salt process vessel with the sparging gas mixture comprising hydrogen and argon.
Embodiment 14: The method of Embodiment 13, wherein contacting molten salt in a molten salt process vessel with a sparging gas mixture comprises contacting molten salt in the molten salt process vessel with the sparging gas mixture comprising hydrogen from about one percent by volume to about fifty percent by volume and argon from about fifty percent to about ninety-nine percent by volume.
Embodiment 15: The method of Embodiment 13, wherein contacting molten salt in a molten salt process vessel with a sparging gas mixture comprises contacting molten salt in the molten salt process vessel with the sparging gas mixture comprising less than or equal to about four percent hydrogen by volume.
Embodiment 16: The method of Embodiment 9, wherein contacting molten salt in a molten salt process vessel with a sparging gas mixture comprises contacting molten salt in the molten salt process vessel with the sparging gas mixture at a sparging gas flowrate of from about one liter of sparging gas per one-hundred liters of molten salt per minute to about ten liters of sparging gas per one-hundred liters of molten salt per minute.
Embodiment 17: The method of Embodiment 9, wherein contacting molten salt in a molten salt process vessel with a sparging gas mixture comprises contacting the molten salt in the molten salt process vessel with the sparging gas mixture heated to a temperature of from about 225 degrees Celsius to about 1,400 degrees Celsius.
Embodiment 18: The method of Embodiment 9, wherein transferring impurities in the molten salt to the surface of the molten salt comprises physically displacing the impurities in the molten salt with the sparging gas mixture.
Embodiment 19: The method of Embodiment 9, wherein transferring impurities in the molten salt to the surface of the molten salt comprises physically displacing the impurities in the molten salt with the sparging gas mixture and transferring the impurities to the surface of the molten salt with the sparging gas mixture.
Embodiment 20: A method of in situ corrosion mitigation in molten salt process equipment, the method comprising: preheating a sparging gas mixture; contacting molten salt in a molten salt process vessel with the preheated sparging gas mixture comprising hydrogen and argon; transferring impurities in the molten salt to a surface of the molten salt with the preheated sparging gas mixture; removing the impurities transferred from the surface of the molten salt; recovering sparging off-gasses discharged from the molten salt process vessel, the sparging off-gasses comprising the preheated sparging gas mixture and one or more of gaseous impurities, liquid impurities, and solid impurities entrained therein; separating at least the hydrogen from the recovered sparging off-gasses; and recycling the hydrogen.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of the disclosure.

1. A method of in situ corrosion mitigation in a molten salt process, the method comprising:
preheating a sparging gas mixture comprising a sparging gas and a carrier gas;
contacting molten salt with the preheated sparging gas mixture; and
transferring impurities in the molten salt to a surface of the molten salt with the preheated sparging gas mixture.

2. The method of claim 1, further comprising removing the impurities transferred to the surface of the molten salt.

3. The method of claim 2, further comprising processing the impurities removed from the surface of the molten salt.

4. The method of claim 1, further comprising discharging sparging off-gasses comprising the preheated sparging gas mixture and one or more of gaseous impurities, liquid impurities and solid impurities entrained within.

5. The method of claim 1, further comprising recovering sparging off-gasses comprising the preheated sparging gas mixture and one or more of gaseous impurities, liquid impurities and solid impurities entrained within.

6. The method of claim 5, further comprising separating the sparging gas of the sparging gas mixture from the sparging off-gasses.

7. The method of claim 6, further comprising recycling the sparging gas separated from the sparging off-gasses.

8. The method of claim 5, further comprising separating the carrier gas of the sparging gas mixture from the sparging off-gasses.

9. A method of in situ corrosion mitigation in a molten salt process, the method comprising:
contacting molten salt in a molten salt process vessel with a sparging gas mixture, the sparging gas mixture comprising one or more sparging gasses and one or more carrier gasses; and
transferring impurities in the molten salt to a surface of the molten salt with the sparging gas mixture.

10. The method of claim 9, wherein contacting molten salt in a molten salt process vessel with a sparging gas mixture comprises contacting molten salt in the molten salt process vessel with the sparging gas mixture exhibiting a purity of at least about 99.9 percent.

11. The method of claim 9, wherein contacting molten salt in a molten salt process vessel with a sparging gas mixture comprises contacting molten salt in the molten salt process vessel with the sparging gas mixture comprising hydrogen and the carrier gas.

12. The method of claim 9, wherein contacting molten salt in a molten salt process vessel with a sparging gas mixture comprises contacting molten salt in the molten salt process vessel with the sparging gas mixture comprising the sparging gas and argon.

13. The method of claim 9, wherein contacting molten salt in a molten salt process vessel with a sparging gas mixture comprises contacting molten salt in the molten salt process vessel with the sparging gas mixture comprising hydrogen and argon.

14. The method of claim 13, wherein contacting molten salt in a molten salt process vessel with a sparging gas mixture comprises contacting molten salt in the molten salt process vessel with the sparging gas mixture comprising hydrogen from about one percent by volume to about fifty percent by volume and argon from about fifty percent to about ninety-nine percent by volume.

15. The method of claim 13, wherein contacting molten salt in a molten salt process vessel with a sparging gas mixture comprises contacting molten salt in the molten salt process vessel with the sparging gas mixture comprising less than or equal to about four percent hydrogen by volume.

16. The method of claim 9, wherein contacting molten salt in a molten salt process vessel with a sparging gas mixture comprises contacting molten salt in the molten salt process vessel with the sparging gas mixture at a sparging gas flowrate of from about one liter of sparging gas per one-hundred liters of molten salt per minute to about ten liters of sparging gas per one-hundred liters of molten salt per minute.

17. The method of claim 9, wherein contacting molten salt in a molten salt process vessel with a sparging gas mixture comprises contacting the molten salt in the molten salt process vessel with the sparging gas mixture heated to a temperature of from about 225 degrees Celsius to about 1,400 degrees Celsius.

18. The method of claim 9, wherein transferring impurities in the molten salt to the surface of the molten salt comprises physically displacing the impurities in the molten salt with the sparging gas mixture.

19. The method of claim 9, wherein transferring impurities in the molten salt to the surface of the molten salt comprises physically displacing the impurities in the molten salt with the sparging gas mixture and transferring the impurities to the surface of the molten salt with the sparging gas mixture.

20. A method of in situ corrosion mitigation in molten salt process equipment, the method comprising:
preheating a sparging gas mixture;
contacting molten salt in a molten salt process vessel with the preheated sparging gas mixture comprising hydrogen and argon;
transferring impurities in the molten salt to a surface of the molten salt with the preheated sparging gas mixture;
removing the impurities transferred from the surface of the molten salt;
recovering sparging off-gasses discharged from the molten salt process vessel, the sparging off-gasses comprising the preheated sparging gas mixture and one or more of gaseous impurities, liquid impurities, and solid impurities entrained therein;
separating at least the hydrogen from the recovered sparging off-gasses; and
recycling the hydrogen.
